(19) United States
(12) Patent Application Publication
(10) Pub. No.: US 2007/0028136 A1
(43) Pub. Date: Feb. 1, 2007

(54) PARITY UPDATE FOOTPRINTS KEPT ON DISK

(75) Inventors: Carl Edward FORHAN, Rochester, MN (US); Robert Edward GALBRAITH, Rochester, MN (US); Adrian Cuenin GERHARD, Rochester, MN (US); Timothy James LARSON, Byron, MN (US); William Joseph MAITLAND JR., Rochester, MN (US)

Correspondence Address: OPPEDAHL & OLSON LLP, P.O. BOX 4850, FRISCO, CO, 80443-4850, US

(73) Assignee: ADAPTEC, INC., Milpitas, CA (US)

(21) Appl. No.: 11/163,346

(22) Filed: Oct. 15, 2005

Related U.S. Application Data
(63) Continuation of application No. PCT/IB05/53253, filed on Oct. 3, 2005.
(60) Provisional application No. 60/595,678, filed on Jul. 27, 2005.

(51) Int. Cl. G06F 11/00

(52) U.S. Cl. 714/6

(57) ABSTRACT

Parity Update Footprints (PUFPs) are kept on the disk drives themselves (rather than in nonvolatile RAM) so that the PUFPs will move along with the RAID arrays and data they protect. This permits effective detection of and recovery from many unexpected-power-loss events, and certain other types of failures, even in a clustered-adapter configuration or with a standalone adapter that has no nonvolatile RAM or only a little nonvolatile RAM. Desirably, many Set PUFP and Clear PUFP operations can be coalesced into each write to the block on the disk which contains the PUFPs, thereby improving system performance.

### CROSS-REFERENCE TO RELATED APPLICATIONS

This application is a continuation of international application number PCT/IB2005/053253, filed Oct. 3, 2005, designating the United States, which application is hereby incorporated herein by reference for all purposes. Application number PCT/IB2005/053253 claims priority from U.S. application No. 60/595,678 filed on Jul. 27, 2005, which application is also hereby incorporated herein by reference for all purposes.

### FIELD OF THE INVENTION

The invention relates generally to DASD (direct access storage device) systems, and relates more particularly to RAID (redundant array of inexpensive disks) systems, and relates most particularly to a goal of reducing to an absolute minimum the risk that information written to the drives of a RAID system could get out of synchronization without being detected and/or corrected.

### BACKGROUND

It is not easy designing RAID systems. Users want RAID systems to be extremely reliable, but they also want the systems not to cost too much money. Finally they want the systems to perform well (that is, to pass data into and out of the system quickly and to provide data very soon after it is asked for).

In a RAID system it nearly always happens that if information is intended to be written to one of the disks, it is also intended that information be written to at least one more disk.
As one example, in a mirrored (RAID 1) system, identical information is intended to be written to both of the drives in the mirrored set.
As a second example, in a RAID 5 system, any time data is being written to one of the data drives, generally it is intended that corresponding updated parity information will be written to a parity drive.
As a third example, in a RAID 6 system, any time data is being written to one of the data drives, generally it is intended that corresponding updated P and Q information will be written to drives carrying corresponding P and Q information.

It follows automatically from the functional definitions of the various RAID levels that the RAID system must keep track of each desired group of disk-writing tasks, and must keep track of whether each particular disk-writing task within the group has been completed. This process of keeping track of groups of disk-writing tasks is typically accomplished by use of a structure which describes a parity update which is in progress, that is, an update of data (i.e. user data) and parity, usually being performed due to a host write operation or an adapter cache drain operation. For convenient reference this structure is referred to herein as a “Parity Update Footprint” or PUFP. The PUFP commonly contains information to identify the parity stripe(s) being updated such as the data disk being written, starting LBA (logical block address) and length of the operation. The PUFP must be made valid in non-volatile storage of some type before the data and parity contained in a major stripe becomes out of synchronization during the parity update process. The PUFP is invalidated once the parity update completes (i.e. the data and parity in the major stripe are once again in synchronization). Other developers of RAID systems have sometimes used the term “Stripe Lock Table Entry” or Mirror Log Entry” to denote a structure used for this purpose. The term “mirror log entry” appears in U.S. Pat. No. 5,991,804.

The designer of a RAID system will necessarily use PUFPs so that the RAID system can detect and recover from race conditions during unexpected power-off events and certain other types of failures. There is the danger that power might fail at a time when one of the disks has been written to and yet another of the disks has not yet been written to. There is also the danger that certain failures could occur which prevent a parity update from completing, much like an abnormal power-off condition. An example of such a failure would be a problem with a device bus to which several or all of the disks are attached, such as if a SCSI bus cable were to get disconnected and reconnected. In the absence of a PUFP, when the system is later powered up, the disks will not be in synchronization, that is, some will contain old data and others will contain new data. Subsequent reads from the disks will run the risk of being incorrect or out of date without the RAID system detecting this condition.

PUFPs are necessary for many RAID levels such as RAID 5 and RAID 6 to ensure that the adapter can detect and/or recover from failures or abnormal power-off conditions during a parity update, which could leave the data and parity in a major stripe out of synchronization with each other and result in data integrity problems. RAID 1 may also use the same mechanism since it is desirable to detect and/or recover when mirror synchronization is lost, for example, during a power off during a write operation which writes the data to both mirrored disks.

The usual implementation of a PUFP is to store it in nonvolatile RAM in a RAID adapter. With the PUFP stored in nonvolatile RAM (e.g. battery-backed static RAM or DRAM) then the RAID system could be suddenly powered down, and then later powered on again, and part of the power-on process can be a check of the nonvolatile RAM to see if there are any PUFPs that had not been invalidated. If there is a PUFP that has not been invalidated, the system knows that at least one disk-writing operation did not finish. This detects such a condition. In addition the PUFP permits finishing the hitherto-unfinished disk-writing operation (assuming the drive that was being written to has not failed), whereby the PUFP can be invalidated, and this recovers from the failure.

Nonvolatile RAM costs money, and the battery that makes the RAM nonvolatile does not last forever. What's more, it is not easy to predict exactly when a battery will fail. This means that the prior-art approach of storing PUFPs in nonvolatile RAM has drawbacks.

Another drawback of some prior-art RAID systems stems from the fact that to solve some other problems, the designer may have chosen to use an N-way RAID adapter configuration (i.e. clustered configuration). This is a configuration in which multiple (two or more) RAID adapters are attached to a common set of disk drives. These RAID adapters may exist in different host systems, physically separated from one another, and on very different power boundaries. In such an environment, it is a common expectation that if one adapter (or the system in which it is located) fails, another adapter can take over the operation of the disks (and RAID arrays) and continue to provide access to the data on the disk drives. But the decision to employ such a configuration, while reducing the risk of loss of data due to certain types of failures, gives rise to new failure modes.

As an example of a failure mode that arises, if PUFPs are simply kept in nonvolatile RAM, as is commonly done on a standalone adapter, then it may be impossible, or very difficult, to extract the PUFPs from a failed adapter to use on an adapter which now needs to take over the operation of the disks/arrays.

In an effort to address this problem, some RAID system designers will “mirror” the PUFPs between the nonvolatile RAMs of the multiple RAID adapters. This does not necessarily work when the adapters are on different power boundaries and may not all be powered on at the time when a particular adapter or system fails.

There has thus been a long-felt need for a way to set up a RAID system so that it can recover from any of a variety of power-loss and failure conditions, and can permit such recovery even in a clustered-adapter configuration. It would be extremely helpful if such an approach could be found that had the potential to address the problem of the cost of non-volatile RAM and the risk that the battery for the RAM will not last forever.

In the case of a standalone RAID adapter that has no nonvolatile RAM, or does not have very much, it would be very helpful if detection and/or correction of problems associated with unexpected power-down could nonetheless be accomplished.

The designer of a RAID system faces not only demands of reliability and cost, but also performance. As will be discussed below, there are a variety of approaches which one might be tempted to employ to address the problems discussed above, and many of them lead to severely degraded performance of the RAID system. It would thus be very helpful if an approach could be found which addressed the problems of recovery from lack of synchronization of drives due to failures or power-down events, and which addressed the desire to be able to accommodate a clustered-adapter configuration, and which addressed cost of nonvolatile RAM and possible battery failure, and which approach did not degrade performance too much.

### SUMMARY OF THE INVENTION

Parity Update Footprints (PUFPs) are kept on the disk drives themselves (rather than or in addition to nonvolatile RAM) so that the PUFPs will move along with the RAID arrays and data they protect. This permits effective detection of and recovery from many unexpected-power-loss events and certain other types of failures even in a clustered-adapter configuration or with a standalone adapter that has no nonvolatile RAM or only a little nonvolatile RAM. Desirably, many Set PUFP and Clear PUFP operations can be coalesced into each write to the block on the disk which contains the PUFPs.

### DESCRIPTION OF THE DRAWING

The invention will be described with respect to a drawing in several figures.

FIG. 1 shows a Parity Update Footprint and a block containing several Parity Update Footprints.

FIG. 2 shows an exemplary RAID-5 array with Partity Update Footprints on disk according to the invention.

### DETAILED DESCRIPTION

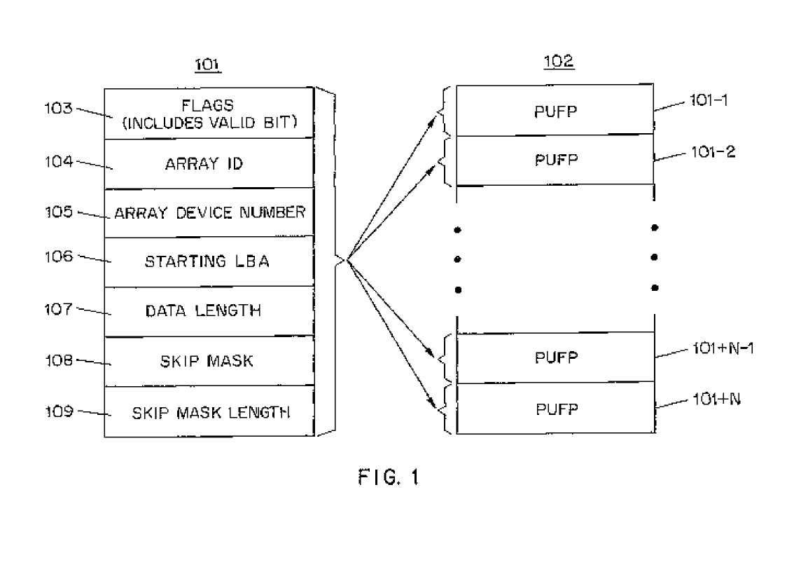

Turning first to FIG. 1, what is shown is a Parity Update Footprint 101 and a block 102 containing several Parity Update Footprints 101-1 through 101-N. In an exemplary embodiment, the PUFP 101 contains:
flags 103, including a valid/invalid bit indicating whether the PUFP has been set or cleared;
array ID 104, which indicates which of several drive arrays is being referred to;
array device number 105 which indicates which device in the array is being referred to;
starting LBA (logical block address) 106 indicating the starting location on the device for the write that is to be performed;
data length 107 indicating how much data is to be written;
skip mask 108 and skip mask length 109, which implement the well-known “skip mask” function for disk drives.

It will be appreciated that the precise elements described here in an exemplary PUFP could be changed in some ways without departing in any way from the invention. As one example, in some older drives a cylinder-head-sector scheme was used instead of an LBA scheme to communicate the starting location of blocks to be stored. With such an older drive the PUFP could have used a CHS value rather than an LBA value. Some drives lack the “skip mask” feature in which case the skip mask and skip mask length values would not be used. Also, importantly, a name for this structure other than “parity update footprint” could be used to describe it, without the use of the structure departing in any way from the invention. In addition, while the invention is described in embodiments using hard disk drives, it should be appreciated that the invention offers its benefits for an array of any type of direct access storage device. Thus the term “direct access storage device” should not be narrowly construed as meaning only traditional rotating magnetic disk drives, but also other types of drives including flash drives.

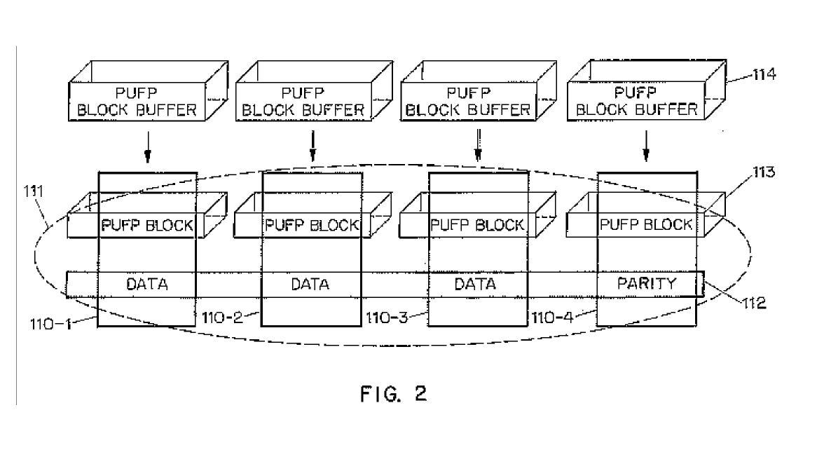

Turning now to FIG. 2, what is shown is an exemplary RAID-5 array 111 with Parity Update Footprints on disk according to the invention. In this embodiment, there are four drives 110-1 through 110-4. The drives are divided up into stripes such as stripe 112, which has data on three drives, in this case 110-1 through 110-3, and parity on a fourth drive, in this case 110-4. (In a different stripe, the drive receiving the parity might not be drive 110-4.)

Each drive 110-1 through 110-4 has a reserved portion of the drive to receive metadata relating to the RAID system, the metadata including a PUFP block 11 3.

The RAID adapter can include a PUFP block buffer 11 4 for each of the drives 110-1 through 110-4, which is used to coalesce multiple “set” and “clear” functions before writing the contents of the buffer 114 to the disk, as described in more detail below. Writes are done from buffer 114 to disk, as required, to effect the “set” and “clear” of the PUFPs.

It will be appreciated that while FIG. 2 shows an exemplary RAID-5 array with four drives, nothing about the invention requires that the level of RAID be 5 nor that the number of drives be four. The RAID level might be 1 or 6 or some other level, the only requirement for the invention to offer its benefits being that the RAID level be one where synchronization across two or more drives is important. The number of drives could be as few as two (for example with RAID 1) or could be larger (for example a RAID-6 system with sixteen or more drives).

One of the benefits of the invention can be appreciated from the above discussion alone, namely that keeping the PUFPs on disk provide an alternative for standalone RAID adapters which, for cost or other reasons, do not have sufficient NVRAM for storage of PUFPs. Where such a standalone RAID adapter is employed, adapter firmware or driver software can establish the PUFP reserved metadata area on each drive, can create PUFPs and stored them to the drives, can “set” and “clear” the PUFPs on the drives, and can detect and recover from the types of failure and power-loss conditions discussed previously.

As mentioned above, however, detection and recovery from certain failure and power-loss conditions is but one of many goals to which a RAID system designer must strive, another of which is to provide satisfactory performance. It will, however, be appreciated that if one were simply to write large numbers of PUFPs to disk (setting and clearing PUFPs) could lead to a RAID system in which performance were substantially degraded because of the large numbers of write activities. After all, at any time that a PUFP on disk is being written (e.g. set or cleared), the drive is not available for other read or write tasks. If one compares how long it takes to write a PUFP to nonvolatile RAM with how long it takes to write a PUFP to disk, the write to disk takes longer. These factors, among others, might prompt some RAID system designers to assume that there is no benefit, only drawbacks, to the notion of writing PUFPs to disk.

It will thus be appreciated that if one is to achieve the benefits of PUFPs on disk, together with maintaining close to the performance that would be available if PUFPs were stored only in non-disk locations (e.g. nonvolatile RAM), more is needed. It is important to arrive at an approach by which Parity Update Footprints can be efficiently kept on disk drives, that is, in a way that minimizes any degradation of performance.

First, A PUFP is kept on the minimum number of disks required for the type of array:
For RAID 1, this is one of the two mirrored disks. Note: If the data disk containing valid PUFPs were to fail causing the array to become degraded, the lost PUFPs would become unneeded.
For RAID 5 doing a normal parity update (i.e. Read-XOR-Write of data/Read-XOR-Write of parity), this could be the single data disk being written. Alternatively the parity disk could always be used. Note: If the data disk containing valid PUFPs were to fail causing the array to become degraded, the lost PUFPs would become unneeded.
For RAID 6 doing a normal parity update (Read-XOR-Write of data/Read-XOR-Write of P parity/Read-XOR-Write of Q parity), this could be the data disk being written, and one of the two parity disks (e.g. the P parity disk). Alternatively both parity disks could always be used. Note: If both disks containing valid PUFPs were to fail causing the array to become degraded, the lost PUFPs would become unneeded.

Second, multiple PUFPs are kept in a single block 102 (FIG. 1) on each disk.

Third, as workloads increase and several PUFPs are desired to be made valid on a disk (i.e. “Set”) in the same timeframe when several PUFPs are desired to be invalidated on a disk (i.e. “Cleared”), many Set and Clear operations can be coalesced into each write to the block on the disk which contains the PUFPs.

Fourth, placing PUFPs on disk may be done only when absolutely needed, such as:
When in a clustered configuration;
When the PUFPs are not or can not be mirrored into the nonvolatile RAM of another adapter;
Only when arrays are degraded (since an optimal array could have all of its parity resynchronized to correct the parity synchronization);
Only when a standalone adapter does not have sufficient nonvolatile RAM for storage of PUFPs.

It will also be appreciated that it may be advantageous to use PUFPs kept on disk together with PUFPs kept in the nonvolatile RAMs of one or more adapters.

As mentioned above, with PUFPs kept in nonvolatile RAM, the PUFPs are read at boot time, so as to learn of parity or data which is out of synchronization due to a failure or abnormal power-off condition while a parity update or other disk write was in progress. Similarly, PUFPs kept on disk can be read at boot time to accomplish the same ends.

As mentioned above, for N-way RAID adapters (i.e. clustered systems), it has been common to mirror the PUFPs between nonvolatile RAMs of the various adapters. Such designs relied on the adapters being on common power boundaries such that it could be counted on that all adapters were powered up and operational when parity updates were being performed. In many RAID systems, however, it is not possible to assume that all of the adapters are on common power boundaries, in which case merely mirroring PUFPs between the nonvolatile RAMs of adapters does not protect fully against the conditions that PUFPs are intended to protect.

Likewise, as mentioned above, for standalone adapters, when sufficient NVRAM was not available for storing PUFPs, PUFPs were simply not kept and there existed a risk of data integrity (e.g. if a disk failed and the array went degraded while parity may have been out of synchronization).

For non-degraded arrays (arrays with no failed disks) it is possible to simply consider the array unprotected and to initiate a full resynchronization of parity for the array when it is detected that PUFPs may have been lost. However, if a disk were to fail and the array become degraded when parity may have been out of synchronization, then a chance of loss of data integrity would exist. This is an example of a situation where a PUFP is an essential aspect of system design so as to be able to detect and/or correct the loss of synchronization.

It will be appreciated that those skilled in the art will have no difficulty at all in devising myriad obvious improvements and variants of the embodiments disclosed here, all of which are intended to be embraced by the claims which follow.

What is claimed is:

1. A method for use with an array of direct access storage devices and a storage device adapter, the method comprising the steps of:
upon booting of the adapter, reading a predetermined reserved area on a first one of the storage devices for the presence of data structures indicative of storage device writes that have not completed;
finding no data structures indicative of storage device writes that have not completed; and
repeating the reading and finding steps for a next one of the storage devices, until the reading and finding steps have been performed for all of the storage devices in the array.

2. A method for use with an array of direct access storage devices and a storage device adapter, the method comprising the steps of:
upon booting of the adapter, reading a predetermined reserved area on a first one of the storage devices for the presence of data structures indicative of storage device writes that have not completed;
in the event of finding a data structure indicative of at least one storage device write that has not completed, performing the at least one storage device write.

3. A method for use with an array of direct access storage devices and a storage device adapter, each storage device having an area reserved for metadata stored by the adapter, the method comprising the steps of:
identifying a group of storage device writes all of which need to be completed if the storage devices are to preserve their synchronization;
for each storage device write, creating a respective data structure indicative of that write not yet having been performed and storing the data structure in a buffer within the storage device adapter;
upon the completion of each storage device write, modifying the respective data structure to be indicative of that write having been performed; and
storing at least two of the data structures to the reserved area of one of the storage devices in a single write operation to the storage device.

4. The method of claim 3 further comprising the steps of:
upon booting of the adapter, reading the predetermined reserved area on a first one of the storage devices for the presence of data structures indicative of storage device writes that have not completed;
finding no data structures indicative of storage device writes that have not completed; and repeating the reading and finding steps for a next one of the storage devices, until the reading and finding steps have been performed for all of the storage devices in the array.

5. The method of claim 3 further comprising the steps of:
upon booting of the adapter, reading a predetermined reserved area on a first one of the storage devices for the presence of data structures indicative of storage device writes that have not completed;
in the event of finding a data structure indicative of at least one storage device write that has not completed, performing the at least one storage device write.

6. A method for use with an array of direct access storage devices and at least first and second storage device adapters, each storage device having an area reserved for metadata stored by the adapter, each storage device adapter communicatively coupled with the array so that each storage device adapter may be used with the array in the event of failure of the other storage device adapter, the method comprising the steps of:
within the first storage device adapter, identifying a group of storage device writes all of which need to be completed if the storage devices are to preserve their synchronization, for each storage device write, creating a respective data structure indicative of that write not yet having been performed and storing the data structure in a buffer within the first storage device adapter, and storing the data structure from the buffer to the reserved area of a one of the storage devices; and
within the second storage device adapter, identifying a group of storage device writes all of which need to be completed if the storage devices are to preserve their synchronization, for each storage device write, creating a respective data structure indicative of that write not yet having been performed and storing the data structure in a buffer within the second storage device adapter, and storing the data structure from the buffer to the reserved area of the one of the storage devices.

7. The method of claim 6 further comprising the steps of:
upon booting of one of the first and second adapters, reading the predetermined reserved area on a first one of the storage devices for the presence of data structures indicative of storage device writes that have not completed;
finding no data structures indicative of storage device writes that have not completed; and
repeating the reading and finding steps for a next one of the storage devices, until the reading and finding steps have been performed for all of the storage devices in the array.

8. The method of claim 6 further comprising the steps of:
upon booting of one of the first and second adapters, reading the predetermined reserved area on a first one of the storage devices for the presence of data structures indicative of storage device writes that have not completed;
in the event of finding a data structure indicative of at least one storage device write that has not completed, performing the at least one storage device write.

9. A method for use with an array of direct access storage devices and a storage device adapter, each storage device having an area reserved for metadata stored by the adapter, the method comprising the steps of:
identifying a group of storage device writes all of which need to be completed if the storage devices are to preserve their synchronization;
for each storage device write, creating a respective data structure indicative of that write not yet having been performed, and
storing the data structure to the reserved area of one of the storage devices;
the method further characterized in that the data structure is not stored in any nonvolatile RAM within the storage device adapter.

10. The method of claim 9 further comprising the steps of:
upon booting of the adapter, reading the predetermined reserved area on a first one of the storage devices for the presence of data structures indicative of storage device writes that have not completed;
finding no data structures indicative of storage device writes that have not completed; and
repeating the reading and finding steps for a next one of the storage devices, until the reading and finding steps have been performed for all of the storage devices in the array.

11. The method of claim 9 further comprising the steps of:
upon booting of the adapter, reading a predetermined reserved area on a first one of the storage devices for the presence of data structures indicative of storage device writes that have not completed;
in the event of finding a data structure indicative of at least one storage device write that has not completed, performing the at least one storage device write.

12. An array of direct access storage devices, the array comprising at least first and second direct access storage devices,
the first direct access storage device comprising an area to which directly addressed writes are performed, and
the second direct access storage device comprising an area to which directly addressed writes are performed, and
a predetermined reserved area containing at least first and second data structures indicative of storage device writes to the area of the first direct access storage device to which directly addressed writes are performed, that have not completed.

13. A storage device system comprising:
an array of direct access storage devices;
an adapter communicatively coupled with the array and having a bus for communicative coupling with a host;
each of the direct access storage devices comprising:
an area to which directly addressed writes are performed, and
a predetermined reserved area disposed to contain a data structure indicative of storage device writes to the area to which directly addressed writes are performed that have not completed;
the predetermined reserved area of at least one of the direct access storage devices comprising a data structure indicative of storage device writes to the area to which directly addressed writes are performed that have not completed.

14. Apparatus for use with an array of direct access storage devices, the apparatus comprising:
a communications bus disposed for communication with the array of direct access storage devices;
means responsive to booting of the apparatus for reading a predetermined reserved area on a first one of the storage devices for the presence of data structures indicative of storage device writes that have not completed;
means responsive to finding no data structures indicative of storage device writes that have not completed, for repeating the reading and finding steps for a next one of the storage devices, until the reading and finding steps have been performed for all of the storage devices in the array;
the previous means further responsive to finding a data structure indicative of at least one storage device write that has not completed, for performing the at least one storage device write.

15. Apparatus for use with an array of direct access storage devices, the apparatus comprising:
a communications bus disposed for communication with the array of direct access storage devices;
a buffer within the apparatus;
means identifying a group of storage device writes all of which need to be completed if the storage devices are to preserve their synchronization;
means responsive to each storage device write, for creating a respective data structure indicative of that write not yet having been performed and storing the data structure in the buffer;
means responsive to the completion of each storage device write, for modifying the respective data structure to be indicative of that write having been performed; and
means coalescing at least two of the data structures to the reserved area of one of the storage devices in to a block stored to the one of the storage devices in a single write operation to the storage device.

16. The apparatus of claim 15 further comprising:
means responsive to booting of the apparatus for reading a predetermined reserved area on a first one of the storage devices for the presence of data structures indicative of storage device writes that have not completed;
means responsive to finding no data structures indicative of storage device writes that have not completed, for repeating the reading and finding steps for a next one of the storage devices, until the reading and finding steps have been performed for all of the storage devices in the array;
the previous means further responsive to finding a data structure indicative of at least one storage device write that has not completed, for performing the at least one storage device write.
